(19) United States
(12) Patent Application Publication
(10) Pub. No.: US 2008/0084654 A1
(43) Pub. Date: Apr. 10, 2008

(54) Segmented utility tower and method

(76) Inventor: Anton Josef Gerich, Bellville, OH (US)

Correspondence Address: DAVID G. HEROLD, 10362 WOODBURN DRIVE, POWELL, OH, 43065, US

(21) Appl. No.: 11/903,951

(22) Filed: Sep. 25, 2007

Related U.S. Application Data
(60) Provisional application No. 60/847,544, filed on Sep. 27, 2006.

(51) Int. Cl. H02B 1/00

(52) U.S. Cl. 361/601

(57) ABSTRACT

A segmented electric utility meter tower provides staged installation of utility service at a customer site. A ground segment, which may be installed at the time of transformer installation, comprising an enclosed wiring channel and a utility wiring ingress, protects utility wiring prior to installing service. A meter segment, to which a utility meter may be preinstalled, comprises an enclosed wiring channel and a utility meter wiring access. The meter segment is mounted on the ground segment at the time of installation of utility service and provides a continuous wiring channel from the wiring ingress to the meter wiring access for interconnecting utility wiring with meter wiring. The segmented utility tower may be adapted for fabrication in cast fiberglass. A lid may provide locked access to the continuous wiring channel for wiring maintenance.

### CROSS-REFERENCE TO RELATED APPLICATIONS

This application claims the benefit of U.S. Provisional Application No. 60/847,544, filed Sep. 27, 2006.

### BACKGROUND—FIELD OF INVENTION

This invention relates generally to utility towers and specifically to segmented utility towers.

### BACKGROUND—DESCRIPTION OF PRIOR ART

Electricity is distributed from the power generation source by high-voltage lines. Close to the point of electric consumption, the voltage is transformed to a lower voltage with a utility transformer. The electricity at a consumer service site is provided through an electric utility meter to monitor electricity usage for billing purposes. The meter generally marks the boundary between the electric utility assets and responsibility and the consumer assets and responsibility. Meter, wiring, transformer, and etc. on the utility side of the meter belong to and are maintained by the utility. Wiring, circuit breaker box, and building entry connection, on the consumer side of the meter belong to and are maintained by the consumer.

The meter is often mounted on a building in which the electricity is used. During building construction, a temporary electric meter is often provided by the utility at the construction site to power construction equipment. Prior to construction completion, the utility mounts the permanent meter on the building, running wires from the transformer to the permanent meter. Subsequent building modifications may require utility involvement to move the meter out of the way of the modification, to another location on the building. In addition, digging in the immediate vicinity of the building, where digging is most likely, may cause additional utility involvement to repair utility assets that may be damaged by the digging. The utility company gets involved in modification or repair of utility assets.

The utility benefits from reducing the number of customer site visits. To this end, the utility would like to permanently mount the meter when the meter is first installed. If the chosen meter location is removed a distance from the building, building modifications and digging in the building vicinity do not disturb the utility assets and require utility maintenance.

Consumer electric service is installed in stages. The first stage entails trenching in the high voltage line drop from the high-voltage distribution to the service site and roughing in the transformer pad. The second stage entails installing the transformer, the utility meter, and wiring the transformer and meter for initial service. The last stage entails moving the meter to the permanent site if the initial utility meter installation was in a temporary location. A lineman is required to wire the transformer and meter. A temporary meter installation requires additional lineman time due to the custom nature of temporary meter installations where the wiring is not preinstalled because it cannot be protected until the meter is installed.

The prior art provides few options for remote meter mounting. The available options are mounting on a wooden or metal pole, or on the transformer housing. Mounting of the meter to the pole and wiring of the meter is done at the site, costing lineman time and money. The prior art does not adequately address utility needs for permanent remote meter mounting. Poles and other available remote utility mounting options do not provide for protecting utility wiring, while allowing wiring maintenance. Both metal and wooden permanent mounting options have limited life due to corrosion and decay.

It is therefore an object of the invention to provide a temporary or permanent utility tower for supporting an electric utility meter.

It is a further object of the invention to provide a utility tower for multiple electric meters.

It is a further object of the invention to provide better staging of utility meter installation.

It is a further object of the invention to provide for pre-assembly of the electric meter to the utility tower.

It is a further object of the invention to reduce utility meter wiring time at the consumer site.

### SUMMARY

The instant invention is a segmented utility tower that enables temporary and permanent electric meter mounting. A first segment, called the ground segment, may be pre-installed at a building site. The ground segment has an enclosed wiring channel and a wiring ingress. The ground segment protects utility wiring pre-installed in the utility tower. The electric meter is mounted on a second segment, called the meter segment that is mounted on and is supported by the ground segment. The meter segment has an enclosed wiring channel with utility meter wiring access. The enclosed wiring channels from the ground segment and meter segment form a continuous wiring channel from the wiring ingress to the meter wiring access. The segmented utility tower may provide lock access to utility wiring.

The segmented utility tower may be installed in stages to reduce total installation time at the service site. The ground segment may be installed when the utility transformer is roughed in, routing the utility wiring through the wiring ingress into the wiring channel. The meter segment may be delivered to the service site preassembled with one or more utility meters. Mounting the meter segment on the ground segment, and interconnecting the meter wiring and the utility wiring completes installation of utility service. A lid covers the continuous wiring channel and secures the utility wiring.

### BRIEF DESCRIPTION OF THE DRAWINGS

FIG. 1 Perspective view of the segmented utility tower

FIG. 2 Connection of electric meter to the utility tower meter segment

FIG. 3 Perspective view of meter installation on utility tower

### DESCRIPTION OF THE PREFERRED EMBODIMENT

Electricity distribution extends from a power generation source by high voltage lines to the vicinity of a service site. A transformer located in proximity to an electric service site drops the voltage from distribution levels to customer service levels. The low-voltage electricity then passes through a utility meter and on to the customer. In general, the utility owns and is responsible for equipment and wiring from the power source to the electric meter and the customer owns and is responsible for equipment and wiring past the meter.

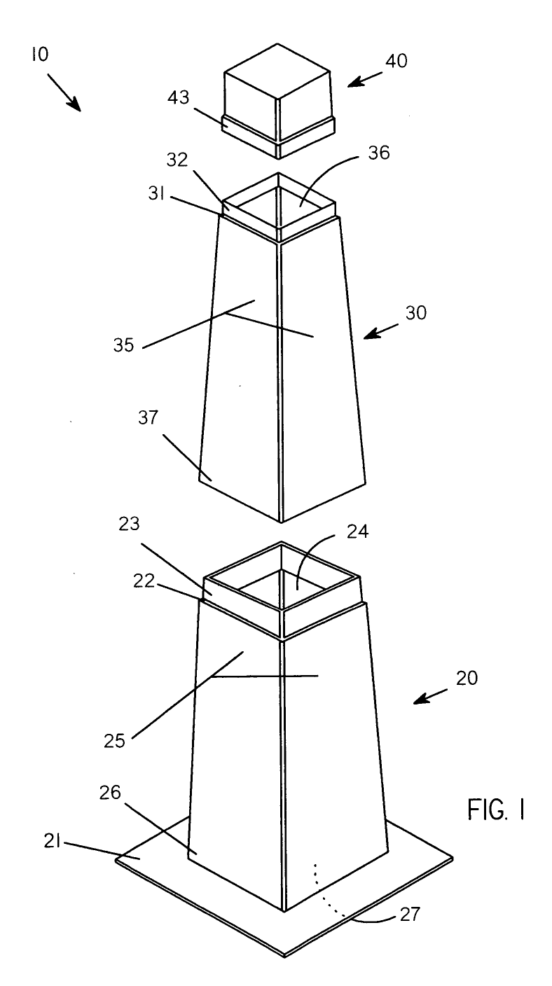

Referring to FIG. 1, a segmented utility tower is shown at 10. The utility tower provides mechanical support and wiring access for a utility meter. Segmented utility tower 10 comprises ground segment 20, meter segment 30, and lid 40. The three pieces are largely formed of cast fiber glass with a gelcoat exterior over laminate. The ground segment and meter segment have reinforced walls 25 and 35 for increased structural integrity.

Ground segment 20 is generally installed below grade and comprises flange 21 at base 26 for stability. Shoulder 22 and lip 23 support meter segment 30, which is mounted directly on top of ground segment 20. Self-tapping screws (not shown) are used to secure meter segment 30 to lip 23. Enclosed wiring channel 24 extends from the top of ground segment 20 through base 26. The opening in base 26 provides ingress 27 for utility wires. Ground segment 20 tapers from the base to the shoulder.

Meter segment 30 comprises shoulder 31 and lip 32. Shoulder 31 and lip 32 support lid 40. The four outside walls of meter segment 30 form an enclosed wiring channel 36, which mates with the enclosed wiring channel 24 of ground segment 20 to form a continuous wiring channel. Lid 40 provides maintenance access to utility wiring contained in channel 36, and protects the contained wiring.

The dimensions of utility tower 10 of the preferred embodiment are as follows. Ground segment 20 is 15 inches square at base 26. Flange 21 is 4 inches wide. Ground segment 20 is 30 inches from base 26 to shoulder 22. Meter segment 30 is 30 inches from base 37 to shoulder 31. Lid 40 is 12 inches tall. The utility tower is tapered from the 15 inch base 26 of ground segment 20 to the 14 inch square top of lid 40.

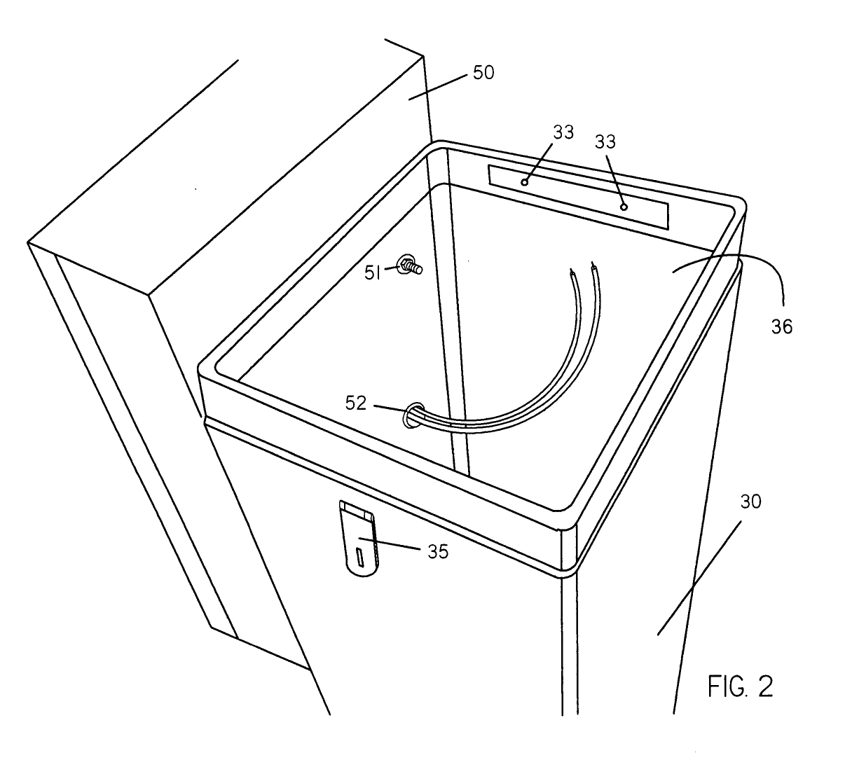

Referring to FIG. 2, utility meter 50 is shown attached to meter segment 30. Hasp 35 and pin receptacles 33 engage a staple (not shown) and locking pins (not shown) from lid 40 to provide lock access to wiring channel 36. Mounting bolts 51 connect meter 50 to meter segment 30. Spacers on bolts 51 between meter 50 and meter segment 30 provide space to remove lid 40 from meter segment 30 without interference from meter 50. Meter wiring access 52 provides meter-wiring access directly from meter 50 to wiring channel 36 of meter segment 30. Meter wiring is connected to utility wiring in meter segment wiring channel 36 and ground segment wiring channel 24.

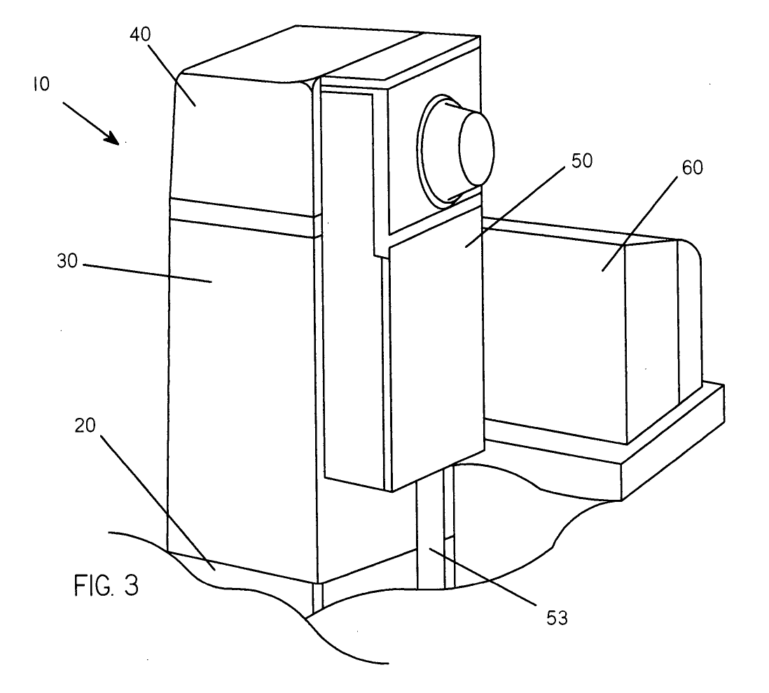

Referring to FIG. 3, meter 50 is shown attached to utility tower 10. Conduit 53 contains customer wiring from meter 50. Also shown is utility transformer 60, which supplies power to meter 50 through utility tower 10. The power for multiple customers may be supplied through utility transformer 60. Each customer must have a separate meter to track electricity consumption for billing purposes. Three utility meters may be mounted on one utility tower. The utility tower of the preferred embodiment is wider than meter 50 to allow for multiple meter attachments without interference. Each meter is mounted on a side of utility tower 10.

The installation of segmented utility tower 10 need not be completed at one time. Ground segment 20 may be installed at a time when the transformer is roughed in and the high-voltage line is trenched in, for instance. A ground segment lid (not shown) similar to lid 40, but slightly larger may be installed on ground segment 20 to protect installed utility wiring from roughed in transformer 60 to ground segment 20. Meter segment 30 may be installed later when the installation of transformer 60 is completed. The utility installation may be complete at the time of first usage of power at a customer site, during construction, for example.

The segmented utility tower may also be used as a temporary tower, while a building on which the meter will be permanently mounted is under construction, for example. In this instance, a utility visit to the site would be required to move the meter and associated wiring from the utility tower to the permanent mounting location.

Electric meter 50 may be mounted on meter segment 30 before delivery to the customer site. Pre mounting of the meter 50 on meter segment 30 reduces the on-site time required to install electric service. With meter 50 mounted on meter segment 30 and pre wired such that the meter wires have been connected to the meter and brought out through wiring access 52 to wiring channel 36, the last steps of installing electric service are mounting meter segment 30 onto ground segment 20 and interconnecting the meter wiring to the utility wiring within wiring channel 36.

Although a preferred embodiment is described herein, it will be understood that the invention is capable of numerous modifications, rearrangements and substitutions of parts without departing from the scope of the invention as defined in the Claims.

What is claimed is:

1. A segmented utility tower comprising:
a) a first segment comprising first structural walls, said first walls forming a first enclosed wiring channel, said first wiring channel having an ingress for utility wiring; and
b) a second segment comprising second structural walls, said second walls forming a second enclosed wiring channel, said second segment having an outside perimeter, said second segment adapted to accept at least one utility meter, mounted on said outside perimeter, said second segment having a meter wiring access to said second wiring channel for utility meter wiring, said second segment adapted to mount on said first segment wherein said first and second wiring channels form a continuous wiring channel from said ingress to said meter wiring access.

2. The segmented utility tower in claim 1, wherein said first and second structural walls are made from fiberglass.

3. The segmented utility tower of claim 1, further comprising a lid covering said continuous wiring channel.

4. The segmented utility tower of claim 3, wherein said lid further comprises a locking mechanism to restrict access to said continuous wiring channel.

5. The segmented utility tower of claim 1, wherein said first segment additionally comprises a mounting flange.

6. A method for installing a utility meter at a utility site, said method comprising:
a) installing a first utility tower segment at a utility site, said first segment comprising a first enclosed wiring channel and a utility wiring ingress, routing utility wires into said first wiring channel through said ingress;
b) mounting at least one utility meter on a second utility tower segment, said second segment comprising a second enclosed wiring channel and a meter wiring access, routing utility meter wiring through said wiring access into said second wiring channel;
c) mounting said second segment on said first segment forming a continuous wiring channel from said first wiring channel and said second wiring channel; and
d) interconnecting said utility meter wiring and said utility wiring in said continuous wiring channel.
